(19) United States
(12) Patent Application Publication
(10) Pub. No.: US 2007/0207788 A1
(43) Pub. Date: Sep. 6, 2007

(54) Radio resource control

(75) Inventors: Vinh Van Phan, Oulu (FI); Markku Vainikka, Kiviniemi (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/591,632

(22) Filed: Nov. 2, 2006

(30) Foreign Application Priority Data
Nov. 3, 2005 (FI) 20055591

(51) Int. Cl. H04Q 7/22

(52) U.S. Cl. 455/414.4

(57) ABSTRACT

Radio resource control in a wireless telecommunication system is provided. The control procedure includes: including a Random Access Channel control information element in a paging message to be transmitted to more than one user terminal in the same cell at the same time by the network element, the Random Access Channel control information element being dependent on the number of user terminals being paged; and controlling the transmissions of the more than one user terminal on the one or more Random Access Channels on the basis of the Random Access Channel control information element.

### FIELD

The invention relates to a method of controlling radio resources in a wireless telecommunications system, to a wireless telecommunications system, to a network element, to a user terminal, to a computer program product encoding a computer program of instructions for executing a computer process for controlling radio resources in a wireless telecommunications system, and to a computer program distribution medium readable by a computer and encoding a computer program of instructions for executing a computer process for controlling radio resources in a wireless telecommunications system.

### BACKGROUND

Random Access Channel (RACH) is an uplink (UL) contention-based common transport channel that is widely used, for example, in mobile cellular systems including future evolutions thereof, such as E-UTRAN (Evolution of Universal Terrestrial Radio Access Network). The Random Access Channel (RACH) is often used for initial access and transmission of short dedicated control and traffic data of user terminals of wireless telecommunications networks.

A paging procedure is used to inform user terminals in idle state, for example, that there is a network originated connection request, an incoming call alert or downlink data activation. Depending on the reason of the paging event, a user terminal responds to the paging message with a specified operation. For example, in the aforementioned cases, the user terminal may perform cell association and connection establishment procedures and become active. At this phase, the user terminal uses the Random Access Channel to communicate with a base station of the wireless telecommunications network.

For example, in E-UTRAN systems it is possible to page several user terminals in the same paging event by including one paging record for each user terminal in the paging message. In future cellular networks, such as E-Utran, a high capacity, in terms of data rates as well as the number of simultaneous user terminals being served in the system, is required. Future cellular networks are also likely deployed for a single-cell and hot-spot system scenarios. Thus, situations where several user terminals in the same cell are paged at the same time are increasing. In response to paging, the several paged user terminals will most likely attempt transmitting on the Random Access Channel at the same time for cell association and connection establishment and becoming active. Thus, collisions during that period are probable. Further, possible data transmission attempts of other user terminals (not paged) in the cell on the Random Access Channel will also reserve valuable radio resources. The collisions will prolong the access and call set-up times of the paged user terminals and also degrade the throughput-delay performance of the Random Access Channel in general.

Sharing of radio resources results in inflexibility in radio resource allocation to the Random Access Channels. Therefore, there is a need to consider improvements for the radio resource control on Random Access Channels.

### BRIEF DESCRIPTION OF THE INVENTION

An object of the invention is to provide an improved method, a user terminal, a wireless telecommunications system, a network element, a computer program product, and a computer program distribution medium. According to a first aspect of the invention, there is provided a method of controlling radio resources in a wireless telecommunications system, where communication between a network element and user terminals of the wireless telecommunications system comprises the network element transmitting paging messages to user terminals and the user terminals transmitting responses to the paging messages on one or more Random Access Channels. The method comprises: including a Random Access Channel control information element in a paging message to be transmitted to more than one user terminal in the same cell at the same time by the network element, the Random Access Channel control information element being dependent on the number of user terminals being paged; and controlling the transmissions of the more than one user terminal on the one or more Random Access Channels on the basis of the Random Access Channel control information element.

According to a second aspect of the invention, there is provided a wireless telecommunications system supporting a Random Access Channel protocol, the wireless telecommunications system including a network element and more than one user terminal, the network element being configured to transmit paging messages to the user terminals and the user terminals being configured to transmit responses to the paging messages on one or more Random Access Channels. The network element comprises: a transmitter for transmitting a paging message to more than one user terminal in the same cell at the same time, a processing unit for including a Random Access Channel control information element in the paging message, the Random Access Channel control information element being dependent on the number of user terminals being paged, and a processing unit for controlling the transmissions of the more than one user terminal on the one or more Random Access Channels on the basis of the Random Access Channel control information element; and each of the more than one user terminal comprises a controller for controlling the transmissions of the user terminal on one or more Random Access Channels on the basis of the received Random Access Channel control information element.

According to a third aspect of the invention, there is provided a network element of a wireless telecommunications system supporting a Random Access Channel protocol, wherein the network element is configured to transmit paging messages to user terminals or the wireless telecommunications system and the user terminals are configured to transmit responses to the paging messages on one or more Random Access Channels. The network element comprises: a transmitter for transmitting a paging message to more than one user terminal in the same cell at the same time, and a processing unit for including a Random Access Channel control information element in the paging message, the Random Access Channel control information element being dependent on the number of user terminals being paged, and a processing unit for controlling the transmissions of the more than one user terminal on the one or more Random Access Channels on the basis of the Random Access Channel control information element.

According to a fourth aspect of the invention, there is provided a user terminal of a wireless telecommunications system supporting a Random Access Channel protocol, wherein a network element of the wireless telecommunications system is configured to transmit paging messages to user terminals or the wireless telecommunications system and the user terminals are configured to transmit responses to the paging messages on one or more Random Access Channels. The user terminal comprises: a receiver for receiving a Random Access Channel control information element included in a paging message being transmitted to more than one user terminal in the same cell at the same time from the network element, the Random Access Channel control information element being dependent on the number of user terminals being paged, and a processing unit for controlling the transmissions of the user terminal on one or more Random Access Channels on the basis of the received Random Access Channel control information element.

According to a fifth aspect of the invention, there is provided a wireless telecommunications system supporting a Random Access Channel protocol, the wireless telecommunications system including a network element and more than one user terminal, the network element comprising transmitting means for transmit paging messages to the user terminals and the user terminals comprising transmitting means for transmitting responses to the paging messages on one or more Random Access Channels. The network element further comprises: transmitting means for transmitting a paging message to more than one user terminal in the same cell at the same time, processing means for including a Random Access Channel control information element in the paging message, the Random Access Channel control information element being dependent on the number of user terminals being paged, and processing means for controlling the transmissions of the more than one user terminal on the one or more Random Access Channels on the basis of the Random Access Channel control information element; and each of the more than one user terminal comprises controlling means for controlling the transmissions of the user terminal on one or more Random Access Channels on the basis of the received Random Access Channel control information element.

According to a sixth aspect of the invention, there is provided a network element of a wireless telecommunications system supporting a Random Access Channel protocol, wherein the network element is configured to transmit paging messages to user terminals of the wireless telecommunications system and the user terminals are configured to transmit responses to the paging messages on one or more Random Access Channels. The network element comprises: transmitting means for transmitting a paging message to more than one user terminal in the same cell at the same time, processing means for including a Random Access Channel control information element in the paging message, the Random Access Channel control information element being dependent on the number of user terminals being paged, and processing means for controlling the transmissions of the more than one user terminal on the one or more Random Access Channels on the basis of the Random Access Channel control information element.

According to a seventh aspect of the invention, there is provided a user terminal of a wireless telecommunications system supporting a Random Access Channel protocol, wherein a network element of the wireless telecommunications system is configured to transmit paging messages to user terminals or the wireless telecommunications system and the user terminals are configured to transmit responses to the paging messages on one or more Random Access Channels, wherein the user terminal comprises: receiving means for receiving a Random Access Channel control information element included in a paging message being transmitted to more than one user terminal in the same cell at the same time from the network element, the Random Access Channel control information element being dependent on the number of user terminals being paged, and processing means for controlling the transmissions of the user terminal on one or more Random Access Channels on the basis of the received Random Access Channel control information element.

According to yet another aspect of the invention, there is provided a computer program product encoding a computer program of instructions for executing a computer process for controlling radio resources in a wireless telecommunications system, where communication between a network element and user terminals of the wireless telecommunications system comprises the network element transmitting paging messages to user terminals and the user terminals transmitting responses to the paging messages on one or more Random Access Channels, the process including: including a Random Access Channel control information element in a paging message to be transmitted to more than one user terminal in the same cell at the same time by the network element, the Random Access Channel control information element being dependent on the number of user terminals being paged; and controlling the transmissions of the more than one user terminal on the one or more Random Access Channels on the basis of the Random Access Channel control information element.

According to yet another aspect of the invention, there is provided a computer program distribution medium readable by a computer and encoding a computer program of instructions for executing a computer process for controlling radio resources in a wireless telecommunications system, where communication between a network element and user terminals of the wireless telecommunications system comprises the network element transmitting paging messages to user terminals and the user terminals transmitting responses to the paging messages on one or more Random Access Channels, the process including: including a Random Access Channel control information element in a paging message to be transmitted to more than one user terminal in the same cell at the same time by the network element, the Random Access Channel control information element being dependent on the number of user terminals being paged; and controlling the transmissions of the more than one user terminal on the one or more Random Access Channels on the basis of the Random Access Channel control information element.

As an advantage, the invention enables a simple and effective method to control radio resources. Collisions can be avoided affectively in Random Access Channel transmissions of the simultaneously paged user terminals. Thus, the throughput-delay performance of the Random Access Channel as well as connection and/or call set-up times for the paged user terminals are improved.

### LIST OF DRAWINGS

In the following, the invention will be described in greater detail with reference to the embodiments and the accompanying drawings, in which

FIG. 1 shows an example of a wireless telecommunications system;

FIG. 2 shows another example of a wireless telecommunications system; and

FIG. 3 illustrates an example of the method of controlling radio resources in a wireless telecommunications system.

### DESCRIPTION OF EMBODIMENTS

FIG. 1 illustrates an example of a wireless telecommunications system to which the present solution may be applied. Below, embodiments of the invention will be described using the UMTS (Universal Mobile Telecommunications System) as an example of the wireless telecommunications system. The invention may, however, be applied to other wireless telecommunications systems. The structure and the functions of such a wireless telecommunications system and those of the associated network elements are only described when relevant to the invention.

The wireless telecommunications system may be divided into a core network (CN) 100, a UMTS terrestrial radio access network (UTRAN) 102, and a user terminal (UE) 104. The core network 100 and the UTRAN 102 form a network infrastructure of the wireless telecommunications system.

The UTRAN 102 is typically implemented with wideband code division multiple access (WCDMA) radio access technology.

The core network 100 includes a serving GPRS support node (SGSN) 108 connected to the UTRAN 102 over an lu PS interface. The SGSN 108 represents the center point of the packet-switched domain of the core network 100. The main task of the SGSN 108 is to transmit packets to the user terminal 104 and to receive packets from the user terminal 104 by using the UTRAN 102. The SGSN 108 may contain subscriber and location information related to the user terminal 104.

The UTRAN 102 includes radio network sub-systems (RNS) 106A, 106B, each of which includes at least one radio network controller (RNC) 110A, 110B and nodes B 112A, 112B, 112C, 112D.

Some functions of the radio network controller 110A, 110B may be implemented with a digital signal processor, memory, and computer programs for executing computer processes. The basic structure and the operation of the radio network controller 110A, 110B are known to one skilled in the art and only the details relevant to the present solution are discussed in detail.

The node B 112A, 112B, 112C, 112D, also known as the base station, implements a Uu interface, through which the user terminal 104 may access the network infrastructure. Some functions of the base station 112A, 112B, 112C, 112D may be implemented with a digital signal processor, memory, and computer programs for executing computer processes. The basic structure and operation of the base station 112A, 112B, 112C, 112D are known to one skilled in the art and only the details relevant to the present solution are discussed in detail.

The user terminal 104 may include two parts: mobile equipment (ME) 114 and a UMTS subscriber identity module (USIM) 116. The mobile equipment 114 typically includes radio frequency parts (RF) 118 for providing the Uu interface. The user terminal 104 further includes a digital signal processor 120, memory 122, and computer programs for executing computer processes. The user terminal 104 may further comprise an antenna, a user interface, and a battery not shown in FIG. 1.

The USIM 116 comprises user-related information and information related to information security in particular, such as, an encryption algorithm.

The basic structure and operation of the user terminal 104 are known to one skilled in the art and only the details relevant to the present solution are discussed in detail.

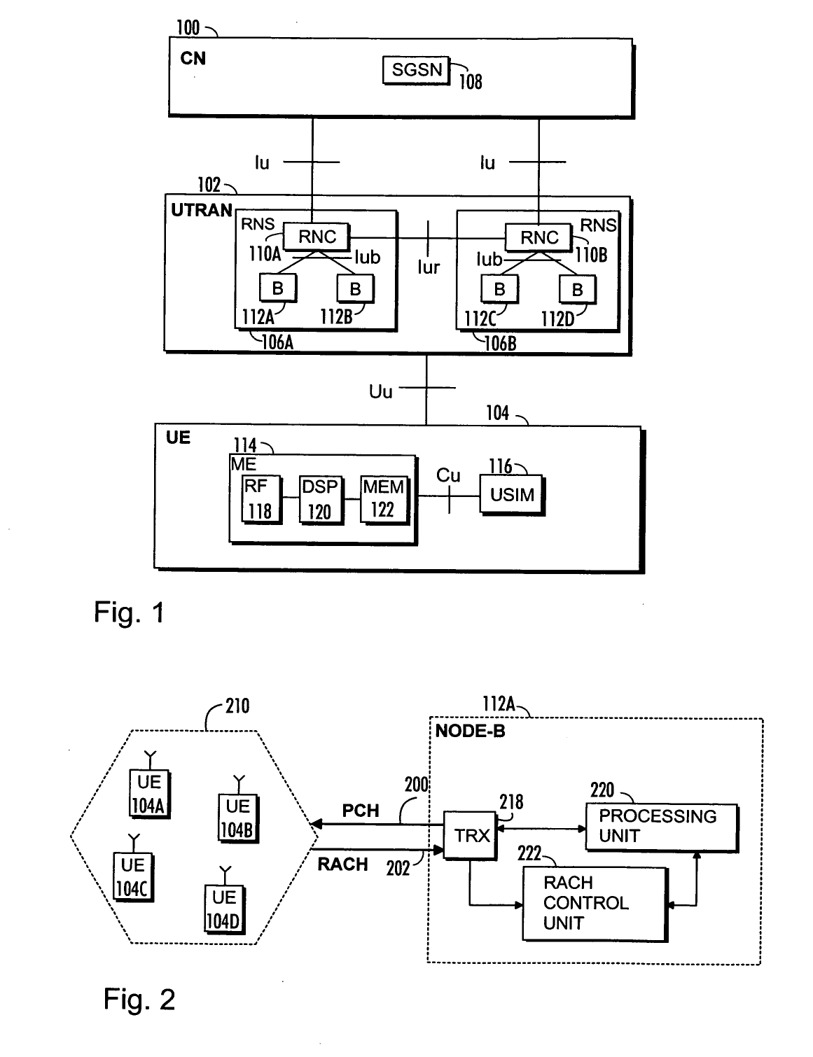

FIG. 2 shows another example of a wireless telecommunications system. The base station 112A may comprise the following elements: one or more transceiver units 218 for communicating, a processing unit 220 for controlling the functions of the base station, and an RACH control unit 222.

The base station 112A communicates paging messages over a downlink transport channel 200 to a number of user terminals 104A, 104B, 104C, 104D in a radio cell 210. The paging channel (PCH) 200 carries data relevant to the paging procedure, for example, when the wireless telecommunications system initiates communication with a user terminal. Each user terminal 104A, 104B, 104C, 104D has been allocated a paging group when registered to the wireless telecommunication system. Paging indicators (PI) of the paging group appear periodically when there are paging messages for any of the user terminals belonging to that paging group. When a user terminal detects a PI, the user terminal decodes the next PCH 200 frame to see whether there was a paging message intended for it.

A Random Access Channel (RACH) 202, in turn, is an uplink transport channel for carrying control information from the user terminals 104A, 104B, 104C, 104D, such as requests to set up a connection. The RACH 202 is typically used for signalling purposes, for registering the user terminals after power-on to the network or for performing location updates after moving from one location area to another or for initiating calls. Usually, the RACH procedure operates such that the user terminal decodes a broadcast channel to find out the available one or more RACH channels and their scrambling codes and signatures, and then selects randomly one of the RACH channels from the group its access class allows it to use.

In an embodiment, the base station 112A is configured to transmit paging messages to the user terminals 104A, 104B, 104C, 104D and the user terminals 104A, 104B, 104C, 104D are configured to transmit responses to the paging messages on one or more Random Access Channels 202.

In an embodiment, when the base station 112A needs to transmit a paging message to more than one user terminal 104A, 104B, 104C, 104D in the same cell 210 at the same time, the processing unit 220 is configured to include a Random Access Channel control information element in the paging message, and to control the transmissions of the more than one user terminal 104A, 104B, 104C, 104D on the one or more Random Access Channels 202 on the basis of the Random Access Channel control information element. Each of the more than one user terminal 104A, 104B, 104C, 104D comprises a controller 120 for controlling the transmissions of the user terminal 104A, 104B, 104C, 104D on one or more Random Access Channels 202 on the basis of the received Random Access Channel control information element.

The Random Access Channel control information element can be generated in the RACH control unit 222 in the base station 112A. In an embodiment, the Random Access Channel control information element is dependent on the number of the user terminals that are being paged. The Random Access Channel control information element may include terms or parameters such as RACH identifier (ID) and RACH Transmit Permission Probability (TPP), also known as Persistence Level in 3G UTRAN. In case the system is configured with several RACH channels, the Random Access Channel control information element includes the RACH identifier (ID). The values of the RACH identifier (ID) and RACH TPP can be set depending on the number of the user terminals 104A, 104B, 104C, 104D being paged in the current paging occasion.

In an embodiment, when the wireless telecommunications system is configured with one Random Access Channel 202, the method further comprises setting the RACH TPP parameter by using a decreasing probability distribution function of the number of paged user terminals. A generic decreasing probability distribution function can be used for defining the RACH TPP, for example, the RACH TPP may be inversely proportional to the number of the simultaneously paged user terminals.

In an embodiment, when the wireless telecommunications system is configured with more than one Random Access Channels 202, the RACH identifier (ID) parameter can be set for each paged user terminal such that the paged user terminals are evenly distributed among the Random Access Channels for transmitting responses to the paging message. In another embodiment, when the wireless telecommunications system is configured with more than one Random Access Channel 202, the RACH identifier (ID) parameter for each paged user terminal can be set such that the paged user terminals are evenly distributed among predetermined selected Random Access Channels for transmitting responses to the paging message, and other Random Access Channels are reserved for other purposes.

In an embodiment, the user terminals 104A, 104B, 104C, 104D are configured to determine whether to transmit on the Random Access Channel on the basis of the RACH identifier (ID) parameter and the RACH Transmit Permission Probability (TPP) parameter. For example, the user terminal may be configured to transmit on the Random Access Channel in the next system frame with a probability value of the TPP parameter, and to refrain from transmitting on the Random Access Channel in the next system frame with a probability of 1-TPP.

In an embodiment, when a RACH TPP parameter is already configured for a Random Access Channel for any user terminal 104A, 104B, 104C, 104D in a cell by broadcasted wireless telecommunications system information, and when the value of the RACH TPP parameter to be transmitted to the paged user terminals is larger than that currently being configured for the cell, the RACH TPP parameter for the paged user terminals can be reset to be the same as the current RACH TPP parameter of the whole cell.

In another embodiment, when the RACH TPP parameter is already configured for a Random Access Channel for any user terminal 104A, 104B, 104C, 104D in the cell by the broadcasted wireless telecommunications system information, and when the value of the RACH TPP parameter to be transmitted to the paged user terminals is larger than that currently being configured for the cell, the RACH TPP parameter of the paged user terminals can be maintained as set and the current RACH TPP parameter configured for other user terminals in the cell can be updated.

In an embodiment, the base station 112A may be configured to reserve a subset of code channels for a dedicated control of the paged user terminals 104A, 104B, 104C, 104D, and to assign the subset of the code channels to the paged user terminals 104A, 104B, 104C, 104D via paging when multiple code channels are used for a contention phase of transmission on Random Access Channel.

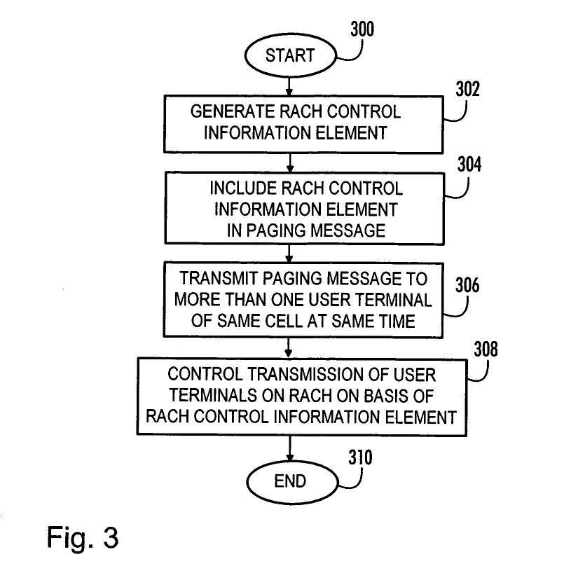

With reference to FIG. 3, an example of methodology according to the embodiments of the invention is shown in a flow chart.

In FIG. 3, the method starts in 300.

In 302, a Random Access Channel control information element is generated in a network element of a wireless telecommunications system. The Random Access Channel control information element may comprise a Random Access Channel identifier (ID) parameter and a Random Access Channel Transmit Permission Probability (TPP) parameter.

In 304, the generated Random Access Channel control information element is included in a paging message to be transmitted to more than one user terminal in the same cell at the same time by the network element, the Random Access Channel control information element being dependent on the number of user terminals being paged.

In 306, the paging message with the generated Random Access Channel control information element is transmitted to the more than one user terminal by the network element.

In 308, the transmissions of the user terminals on one or more Random Access Channels are controlled on the basis of the Random Access Channel control information element.

The method ends in 310.

The method is based on the knowledge that multiple user terminals may happen to be paged at the same time and these user terminals, in turn, will likely attempt to transmit on the Random Access Channel after receiving the paging message for required cell association and connection set-up. The method does not require great changes in existing systems and procedures nor notable signalling or processing overhead. The implementation of the method is thus straightforward, and flexible in the choice of TPP for optimal tradeoffs between throughput and delay over the Random Access Channel.

In an aspect, the invention provides a computer program product encoding a computer program of instructions for executing a computer process for controlling radio resources in a wireless telecommunications system, where communication between a network element and user terminals of the wireless telecommunications system comprises the network element transmitting paging messages to user terminals and the user terminals transmitting responses to the paging messages on one or more Random Access Channels.

In another aspect, the invention provides a computer program distribution medium readable by a computer and encoding a computer program of instructions for executing a computer process for controlling radio resources in a wireless telecommunications system, where communication between a network element and user terminals of the wireless telecommunications system comprises the network element transmitting paging messages to user terminals and the user terminals transmitting responses to the paging messages on one or more Random Access Channels.

The distribution medium may include a computer readable medium, a program storage medium, a record medium, a computer readable memory, a computer readable software distribution package, a computer readable signal, a computer readable telecommunications signal, and/or a computer readable compressed software package.

An embodiment of the computer process are shown and described in conjunction with FIG. 3.

The computer program may be executed in the processing unit 220 of the network element 112A to 112D. Some process steps may be executed in the digital signal processor 120 of the user terminal 104. Some process steps may be executed, depending on the embodiment, in the digital signal processor of the radio network controller 110A, 110B.

Even though the invention has been disclosed above with reference to an example according to the accompanying drawings, it is clear that the invention is not restricted thereto but can be modified in several ways within the scope of the appended claims.

1. A method of controlling radio resources in a wireless telecommunications system, where communication between a network element and user terminals of the wireless telecommunications system comprises the network element transmitting paging messages to user terminals and the user terminals transmitting responses to the paging messages on one or more Random Access Channels, the method comprising:
including a Random Access Channel control information element in a paging message to be transmitted to more than one user terminal in a same cell at the same time by the network element, the Random Access Channel control information element being dependent on a number of user terminals being paged; and
controlling the transmissions of the more than one user terminal on the one or more Random Access Channels on the basis of the Random Access Channel control information element.

2. The method of claim 1, wherein the Random Access Channel control information element comprises at least one of: a Random Access Channel identifier (ID) parameter and a Random Access Channel Transmit Permission Probability (TPP) parameter.

3. The method of claim 2, wherein when the wireless telecommunications system is configured with one Random Access Channel, and the method further comprises setting the Random Access Channel Transmit Permission Probability (TPP) parameter by using a decreasing probability distribution function of the number of user terminals being paged.

4. The method of claim 3, wherein the Random Access Channel Transmit Permission Probability (TPP) parameter is inversely proportional to a number of the user terminals being paged at the same time.

5. The method of claim 2, wherein when the wireless telecommunications system is configured with more than one Random Access Channel, and the method further comprises setting the Random Access Channel identifier (ID) parameter for each user terminal being paged such that the user terminals being paged are evenly distributed among the Random Access Channels for transmitting responses to the paging messages.

6. The method of claim 2, wherein when the wireless telecommunications system is configured with more than one Random Access Channel, the method further comprises setting the Random Access Channel identifier (ID) parameter for each user terminal being paged such that the user terminals being paged are evenly distributed among predetermined selected Random Access Channels for transmitting responses to the paging messages, and other Random Access Channels are reserved for other purposes.

7. The method of claim 2, the method further comprising determining, by a user terminal, whether to transmit on the Random Access Channel on the basis of the Random Access Channel identifier (ID) parameter and the Random Access Channel Transmit Permission Probability (TPP) parameter.

8. The method of claim 7, the method further comprising determining to transmit on the Random Access Channel in a next wireless telecommunications system frame with a probability value of the TPP parameter, and determining to refrain from transmitting on the Random Access Channel in the next wireless telecommunications system frame with a probability of 1-TPP.

9. The method of claim 2, wherein when the Random Access Channel Transmit Permission Probability (TPP) parameter is configured for the Random Access Channel for any user terminal in a cell by broadcasted wireless telecommunications system information, and when the value of the Random Access Channel Transmit Permission Probability (TPP) parameter to be transmitted to the user terminals being paged is larger than a value currently being configured for the cell, then the method further comprises resetting the Random Access Channel Transmit Permission Probability (TPP) parameter for the user terminals being paged to be the same as a current Random Access Channel Transmit Permission Probability (TPP) parameter of the cell.

10. The method of claim 2, wherein when a Random Access Channel Transmit Permission Probability (TPP) parameter is configured for a Random Access Channel for any user terminal in a cell by a broadcasted wireless telecommunications system information, and when a value of the Random Access Channel Transmit Permission Probability (TPP) parameter to be transmitted to the user terminals being paged is larger than a current TPP parameter being configured for the cell, then the method further comprises maintaining the Random Access Channel Transmit Permission Probability (TPP) parameter of the user terminals being paged and updating the Random Access Channel Transmit Permission Probability (TPP) parameter configured for other user terminals in the cell.

11. The method of claim 1, the method further comprising reserving a subset of code channels for a dedicated control of the user terminals being paged, and assigning a subset of code channels to the user terminals being paged via paging when multiple code channels are used for a contention phase of transmission on the Random Access Channel.

12. A wireless telecommunications system supporting a Random Access Channel protocol, the wireless telecommunications system including a network element and more than one user terminal, the network element being configured to transmit paging messages to the user terminals and the user terminals being configured to transmit responses to the paging messages on one or more Random Access Channels, wherein the network element comprises:
a transmitter for transmitting paging messages to more than one user terminal in a same cell at a same time,
a processing unit for including a Random Access Channel control information element in the paging messages, the Random Access Channel control information element being dependent on a number of user terminals being paged, and a processing unit for controlling transmissions of the more than one user terminal on the one or more Random Access Channels on the basis of the Random Access Channel control information element; and
each of the more than one user terminals comprises a controller for controlling the transmissions of the user terminal on one or more Random Access Channels on the basis of the received Random Access Channel control information element.

13. The wireless telecommunications system of claim 12, wherein the Random Access Channel control information element comprises at least one of: a Random Access Channel identifier (ID) parameter and a Random Access Channel Transmit Permission Probability (TPP) parameter.

14. The wireless telecommunications system of claim 13, wherein when the wireless telecommunications system is configured with one Random Access Channel, the network element is configured to set the Random Access Channel Transmit Permission Probability (TPP) parameter by using a decreasing probability distribution function of the number of user terminals being paged.

15. The wireless telecommunications system of claim 14, wherein the Random Access Channel Transmit Permission Probability (TPP) parameter is inversely proportional to a number of the user terminals being paged at the same time.

16. The wireless telecommunications system of claim 13, wherein when the wireless telecommunications system is configured with more than one Random Access Channel, the network element is further configured to set the Random Access Channel identifier (ID) parameter for each user terminal being paged such that the user terminals being paged are evenly distributed among the Random Access Channels for transmitting responses to the paging message.

17. The wireless telecommunications system of claim 13, wherein when the wireless telecommunications system is configured with more than one Random Access Channel, the network element is further configured to set the Random Access Channel identifier (ID) parameter for each user terminal being paged such that the user terminals being paged are evenly distributed among predetermined selected Random Access Channels for transmitting responses to the paging message, and other Random Access Channels are reserved for other purposes.

18. The wireless telecommunications system of claim 13, wherein one or more user terminals are configured to determine whether to transmit on the Random Access Channel on the basis of the Random Access Channel identifier (ID) parameter and the Random Access Channel Transmit Permission Probability (TPP) parameter.

19. The wireless telecommunications system of claim 18, wherein the one or more user terminals are configured to determine to transmit on the Random Access Channel in the next wireless telecommunications system frame with a probability value of the TPP parameter, and determining to refrain from transmitting on the Random Access Channel in the next wireless telecommunications system frame with a probability of 1-TPP.

20. The wireless telecommunications system of claim 13, wherein when a Random Access Channel Transmit Permission Probability (TPP) parameter is configured for the one or more Random Access Channels for any user terminal in a cell by broadcasting wireless telecommunications system information, and when the value of the Random Access Channel Transmit Permission Probability (TPP) parameter to be transmitted to the user terminals being paged is larger than a TPP parameter currently being configured for the cell, the network element is further configured to reset the Random Access Channel Transmit Permission Probability (TPP) parameter for the user terminals being paged to be the same as the currently configured Random Access Channel Transmit Permission Probability (TPP) parameter of the cell.

21. The wireless telecommunications system of claim 13, wherein when the Random Access Channel Transmit Permission Probability (TPP) parameter is configured for a Random Access Channel for any user terminal in a cell by broadcasting wireless telecommunications system information, and when the value of the Random Access Channel Transmit Permission Probability (TPP) parameter to be transmitted to the user terminals being paged is larger than a TPP parameter currently being configured for the cell, the network element is further configured to maintain the Random Access Channel Transmit Permission Probability (TPP) parameter of the user terminals being paged and to update the Random Access Channel Transmit Permission Probability (TPP) parameter configured for other user terminals in the cell.

22. The wireless telecommunications system of claim 12, wherein the network element is further configured to reserve a subset of code channels for a dedicated control of the user terminals being paged, and to assign the subset of the code channels to the user terminals being paged via paging when multiple code channels are used for a contention phase of transmission on the Random Access Channel.

23. A network element of a wireless telecommunications system supporting a Random Access Channel protocol, wherein the network element is configured to transmit paging messages to user terminals of the wireless telecommunications system and the user terminals are configured to transmit responses to the paging messages on one or more Random Access Channels, wherein the network element comprises:
a transmitter for transmitting a paging message to more than one user terminal in a same cell at the same time, and
a processing unit for including a Random Access Channel control information element in the paging message, the Random Access Channel control information element being dependent on a number of user terminals being paged, and
a processing unit for controlling the transmissions of the more than one user terminal on the one or more Random Access Channels on the basis of the Random Access Channel control information element.

24. The network element of claim 23, wherein the Random Access Channel control information element comprises at least one of: a Random Access Channel identifier (ID) parameter and a Random Access Channel Transmit Permission Probability (TPP) parameter.

25. The network element of claim 24, wherein when the wireless telecommunications system is configured with one Random Access Channel, the network element is configured to set the Random Access Channel Transmit Permission Probability (TPP) parameter by using a decreasing probability distribution function of the number of paged user terminals.

26. The network element of claim 24, wherein when the wireless telecommunications system is configured with more than one Random Access Channel, the network element is further configured to set the Random Access Channel identifier (ID) parameter for each paged user terminal such that the paged user terminals are evenly distributed among the Random Access Channels for transmitting responses to the paging message.

27. The network element of claim 24, wherein when the wireless telecommunications system is configured with more than one Random Access Channel, the network element is further configured to set the Random Access Channel identifier (ID) parameter for each paged user terminal such that the paged user terminals are evenly distributed among predetermined selected Random Access Channels for transmitting responses to the paging message, and other Random Access Channels are reserved for other purposes.

28. The network element of claim 24, wherein when a Random Access Channel Transmit Permission Probability (TPP) parameter is configured for a Random Access Channel for any user terminal in a cell by broadcasted wireless telecommunications system information, and when the value of the Random Access Channel Transmit Permission Probability (TPP) parameter to be transmitted to the paged user terminals is larger than a TPP parameter currently being configured for the cell, the network element is further configured to reset the Random Access Channel Transmit Permission Probability (TPP) parameter for the paged user terminals to be the same as the current Random Access Channel Transmit Permission Probability (TPP) parameter of the cell.

29. The network element of claim 24, wherein when the Random Access Channel Transmit Permission Probability (TPP) parameter is configured for the Random Access Channel for any user terminal in a cell by broadcasting wireless telecommunications system information, and when the value of the Random Access Channel Transmit Permission Probability (TPP) parameter to be transmitted to the paged user terminals is larger than a current TPP value being configured for the cell, the network element is further configured to maintain the Random Access Channel Transmit Permission Probability (TPP) parameter of the paged user terminals and to update the Random Access Channel Transmit Permission Probability (TPP) parameter configured for other user terminals in the cell.

30. A user terminal of a wireless telecommunications system supporting a Random Access Channel protocol, wherein a network element of the wireless telecommunications system is configured to transmit paging messages to user terminals or the wireless telecommunications system and the user terminals are configured to transmit responses to the paging messages on one or more Random Access Channels, wherein the user terminal comprises:
a receiver for receiving a Random Access Channel control information element included in a paging message being transmitted to more than one user terminal in the same cell at the same time from the network element, the Random Access Channel control information element being dependent on a number of user terminals being paged, and
a processing unit for controlling the transmissions of the user terminal on one or more Random Access Channels on the basis of the received Random Access Channel control information element.

31. The user terminal of claim 30, wherein the Random Access Channel control information element comprises at least one of: a Random Access Channel identifier (ID) parameter and a Random Access Channel Transmit Permission Probability (TPP) parameter.

32. A wireless telecommunications system supporting a Random Access Channel protocol, the wireless telecommunications system including a network element and more than one user terminal, the network element comprising a first transmitting means for transmitting paging messages to the user terminals and the user terminals comprising a second transmitting means for transmitting responses to the paging messages on one or more Random Access Channels, wherein the network element further comprises:
the first transmitting means for transmitting a paging message to more than one user terminal in the same cell at the same time,
processing means for including a Random Access Channel control information element in the paging message, the Random Access Channel control information element being dependent on a number of user terminals being paged, and processing means for controlling the transmissions of the more than one user terminal on the one or more Random Access Channels on the basis of the Random Access Channel control information element; and
each of the more than one user terminals comprises controlling means for controlling the transmissions of the user terminal on one or more Random Access Channels on the basis of the received Random Access Channel control information element.

33. The wireless telecommunications system of claim 32, wherein the Random Access Channel control information element comprises at least one of: a Random Access Channel identifier (ID) parameter and a Random Access Channel Transmit Permission Probability (TPP) parameter.

34. A network element of a wireless telecommunications system supporting a Random Access Channel protocol, wherein the network element is configured to transmit paging messages to user terminals of the wireless telecommunications system and the user terminals are configured to transmit responses to the paging messages on one or more Random Access Channels, wherein the network element comprises:
transmitting means for transmitting a paging message to more than one user terminal in the same cell at the same time,
first processing means for including a Random Access Channel control information element in the paging message, the Random Access Channel control information element being dependent on the number of user terminals being paged, and
second processing means for controlling the transmissions of the more than one user terminal on the one or more Random Access Channels on the basis of the Random Access Channel control information element.

35. The network element of claim 34, wherein the Random Access Channel control information element comprises at least one of: a Random Access Channel identifier (ID) parameter and a Random Access Channel Transmit Permission Probability (TPP) parameter.

36. A user terminal of a wireless telecommunications system supporting a Random Access Channel protocol, wherein a network element of the wireless telecommunications system is configured to transmit paging messages to user terminals or the wireless telecommunications system and the user terminals are configured to transmit responses to the paging messages on one or more Random Access Channels, wherein the user terminal comprises:
receiving means for receiving a Random Access Channel control information element included in the paging message being transmitted to more than one user terminal in the same cell and at the same time from the network element, the Random Access Channel control information element being dependent on a number of user terminals being paged, and
processing means for controlling the transmissions of the user terminal on one or more Random Access Channels on the basis of the received Random Access Channel control information element.

37. The user terminal of claim 36, wherein the Random Access Channel control information element comprises at least one of: a Random Access Channel identifier (ID) parameter and a Random Access Channel Transmit Permission Probability (TPP) parameter.

38. A computer program product embodied on a computer readable medium and containing a computer program of instructions for executing a computer process for controlling radio resources in a wireless telecommunications system, where communication between a network element and user terminals of the wireless telecommunications system comprises the network element transmitting paging messages to user terminals and the user terminals transmitting responses to the paging messages on one or more Random Access Channels, the process including:
including a Random Access Channel control information element in a paging message to be transmitted to more than one user terminal in a same cell at the same time by the network element, the Random Access Channel control information element being dependent on a number of user terminals being paged; and
controlling the transmissions of the more than one user terminal on the one or more Random Access Channels on the basis of the Random Access Channel control information element.

39. The computer program product of claim 38, wherein the Random Access Channel control information element comprises at least one of: a Random Access Channel identifier (ID) parameter and a Random Access Channel Transmit Permission Probability (TPP) parameter.

40. A computer program distribution medium embodied on a computer readable medium readable by a computer and encoding a computer program of instructions for executing a computer process for controlling radio resources in a wireless telecommunications system, where communication between a network element and user terminals of the wireless telecommunications system comprises the network element transmitting paging messages to user terminals and the user terminals transmitting responses to the paging messages on one or more Random Access Channels, the process including:
including a Random Access Channel control information element in a paging message to be transmitted to more than one user terminal in a same cell at the same time by the network element, the Random Access Channel control information element being dependent on a number of user terminals being paged; and
controlling the transmissions of the more than one user terminal on the one or more Random Access Channels on the basis of the Random Access Channel control information element.

41. The computer program distribution medium of claim 40, the distribution medium comprising a computer readable medium, a program storage medium, a record medium, a computer readable memory, a computer readable software distribution package, a computer readable signal, a computer readable telecommunications signal, and a computer readable compressed software package.
